(19) United States
(12) Patent Application Publication
(10) Pub. No.: US 2018/0174479 A1
(43) Pub. Date: Jun. 21, 2018

(54) Method and Apparatus for Teaching and Cognitive Enhancement

(71) Applicant: Kenneth Wesson, San Jose, CA (US)

(72) Inventor: Kenneth Wesson, San Jose, CA (US)

(21) Appl. No.: 15/895,709

(22) Filed: Feb. 13, 2018

Related U.S. Application Data
(63) Continuation of application No. 15/477,520, filed on Apr. 3, 2017.
Application No. 15/477,520 is a division of application No. 14/218,483, filed on Mar. 18, 2014, now abandoned.
(60) Provisional application No. 61/803,075, filed on Mar. 18, 2013.

(51) Int. Cl. G09B 19/00; G09B 3/02

(52) U.S. Cl. CPC G09B 19/00; G09B 3/02

(57) ABSTRACT

The present invention is a teaching and learning tool built on the principle that the human sense of touch makes a significant contribution in the visualization of objects. Sighted individuals can produce visual images inside the brain (commonly referred to as the “mind's eye”) via the sense of touch, where we use our minds, rather than our eyes, to visualize concrete objects allowing us to “get a picture” of that object. A “brain-sight” apparatus is disclosed that provides a box for containing object manipulatives and/or math manipulatives, two openings for receiving hands of a user, which openings are covered by a veil such that the user cannot see into the box. A user who places his hands into the box and manipulates the object manipulatives and/or math manipulatives in response to a posed problem, and then solves the posed problem in a traditional manner, benefits from cognitive enhancement provided by multi-modal stimulation of the somatosensory cortex and lateral occipital cortex.

### CROSS-REFERENCE TO RELATED APPLICATIONS

The present application is a continuation of co-pending U.S. patent application Ser. No. 15/477,520 filed on Apr. 3, 2017, which is a divisional application from U.S. patent application Ser. No. 14/218,483 filed on Mar. 18, 2014, which is currently co-pending, and which claims the benefit of U.S. Provisional Application No. 61/803,075 filed on Mar. 18, 2013 entitled Method and Apparatus for Teaching and Cognitive Enhancement, all of which are incorporated by reference herein and for which benefit of the priority date is hereby claimed.

### FEDERALLY SPONSORED RESEARCH

Not applicable.

### SEQUENCE LISTING OR PROGRAM

Not applicable.

### FIELD OF INVENTION

The present invention relates to teaching aids for children. More specifically, the invention is directed to enhancing cognitive performance through multi-modal stimulation of the somatosensory cortex and lateral occipital cortex.

### BACKGROUND OF THE INVENTION

Educating students in classrooms generally occurs through the use of textbooks, lectures or software programs. In either case, tactile modalities are not used in current teaching paradigms.

Scores of tactile experiences activate the amygdala, which adds an emotional dimension to our tactile memories. Neuroscientists have discovered that when you look at an object, your brain not only processes what the object looks like, but the brain also remembers what the object feels like when touching it. Eventually, the entire world becomes represented by our past sensory experiences. Human brains capture and store physical sensations, and then replay them when prompted by just viewing the corresponding visual image.

Humans have evolved the ability to accommodate a symphony of relevant sensory inputs simultaneously. When we hear a loud noise behind us, we turn to see what caused the noise. The visual, auditory and association cortices attempt to make sense of the clamor. Vision becomes symbiotic and additive, rather than separate to hearing, by append another dimension to the experience.

While 13% of all Kindergarten-12 students are auditory learners, over 90% of American academic instruction is delivered through textbooks, reading materials and lectures nearly 95% of the time. However, most early learning is self-initiated learning that comes by way of multimodal first-hand explorations, which are the keys to long-term cognitive development. Expanding the number of classroom opportunities where children can exploit the incredible power of their senses will generate deeper learning results and higher levels of student achievement.

### SUMMARY OF THE INVENTION

A brain-sight box is teaching and learning tool built on the principle that the human sense of touch makes a significant contribution in the visualization of objects. Sighted individuals can produce visual images inside the brain (commonly referred to as the “mind's eye”) via the sense of touch, where we use our minds, rather than our eyes, to visualize concrete objects allowing us to “get a picture” of that object. Through tactile sensory input, we perceive the “qualia” (Latin for “aspects”) of an object. It is the qualia that we use to comprehend and subsequently explain the qualitative or subjective features in objects. The somatosensory cortex, where the sense of touch is processed in the brain, is directly connected to the lateral occipital cortex, the brain region responsible for processing the sense of sight. Tactile activations in the lateral occipital cortex turn out to be essential, rather than tangential, to visual recognition. Multi-modal recognition by these brain regions is what makes for human “brain-sight” experiences.

### Sensory System

Inside the brain, complex layers of interconnected sensory networks merge together seamlessly to produce a single experience. Horizontal lines, vertical lines, color, shape, size, motion, direction, etc., are fused together leaving no perceptual holes in an experience. Just as more than 30 separate brain modules participate in constructing a single visual image, when one sensory system has been activated, the other senses do not assume the role of an uninvolved spectator. Nineteen human senses have been identified, which often combine to produce a perception. It would have been significantly disadvantageous for our senses to evolve completely disconnected from one another, each standing in a queue to deliver disjointed information to the brain. Instead, the multiple inputs from divergent brain circuits are processed to generate a single unified experience. The various elements that make up a perception frequently involve pathways located in multiple brain regions. The ability to create constructs in the “mind's eye” involves far more complex brain processing than mere “vision.” Instead, our perceptions are a collaboration of networks widely distributed throughout the brain.

When we listen to a song, we hear the melody, the beat, the lyrics, the instruments, and the voice that make the “music.” Looking at the squiggly lines on a piece of paper, the letters form words, the words stretch into sentences, and the sentences make up a coherent paragraph. Once read, collectively not separately, each contributes to meaning. While it is customary to assert that we “see with our eyes, touch with our hands, and hear with our ears,” we live in a simultaneous universe where sensory events, and their constituent elements, also have a similar natural tendency to overlap.

### Touch

Human skin is able to detect the presences of an insect, whose weight is calibrated in the milligrams. Although a precise measurement of the miniscule degree of pressure exerted by small insects is next to impossible, it is sufficient enough to trigger a sensory warning alarm. Two layers of approximately a few millimeters thick rest above a complex network of sensory detectors whose sensitivity is quite high. The skin shrouds the muscles, body tissues, bodily fluids and internal organs keeping the internal systems, muscles, soft tissues and blood shielded safely from injury and the countless dangers posed by toxic microscopic invaders.

Although the skin has the miraculous power to mend itself, even a tiny intrusion into the 2-3 millimeter-thin covering is instantly transmitted to the executive center in the brain, which coordinates a response to the breach. Any intrusion warrants our conscious attention or a timely defensive response, sometimes occurring in reverse order where our reaction precedes our conscious awareness. Foreign objects, toxins, air, fluids and other living organisms can seldom penetrate the boundary of the human body's skin. Even when unconscious, sensory systems are seldom completely “off-line.” Instead, they remain poised to capture any vital changes around us, even those which are seemingly minor.

The sense of touch is the composite of three sensory qualities—temperature, pain, and pressure, which can be experienced individually or in various combinations of the three. Characteristically, the broad swatches of the human skin are classified as either hairy or glabrous (hairless). These categories are best represented by the palms and backsides of your hands. Together, they put us in instantaneous contact with the outer world.

When this skin is pressed, poked, vibrated, or stroked, there are specialized corpuscles that respond to the four stages of perception: 1) detection, 2) amplification, 3) discrimination (among several stimuli), and 4) adaptation (the reduction in response to a stimulus, e.g., we are only consciously aware of our clothes during the moments we put them on). Over 5 million touch receptors for experiencing light or heavy pressure, warmth or coldness, pain, etc., cover the entire body sending essential information to the brain via a massive sensory expressway. However, the distribution of receptor cells is undemocratically concentrated into those parts of the body that are most involved in direct tactile perception, which partially explains why hands-on learning is so incredibly effective as a learning tool at home and in school. Wherever the hands go, that is where the brain focuses its attention. For decades, these receptor fields were thought to be fixed and unchanging. Instead, cortical representations and sensory projections are rapidly reorganized following injury or surgical alteration to specific areas of the body.

When it comes to sensory acuity, the hand is to the human sense of touch, what the fovea is to our sense of vision. Respectively, both house exceptionally sensitive receptive fields that quickly send the brain a wealth of sensory information with optimum levels of details and discrimination. The corresponding brain areas for touch and sight dedicate a substantial amount of cortical real estate to each of these senses.

As the hands and fingers move across an object, receptor cells respond to the infinitesimal indentations created on the surface of the skin, giving us priceless data disclosing the shape, texture, hardness and form of that particular object. Interestingly, reading Braille does not require abnormally sensitive fingers. On an otherwise completely flat surface, the human fingertip can detect a raised dot 0.04 mm wide and measuring only 0.006 mm high. A typical Braille dot is nearly 170 times that height suddenly rendering it an “easy read” for our fingers.

There are two main layers of the human skin, each of which performs distinctly different functions. The wafer-thin 0.05-1.5 mm epidermis, which varies in thickness according to the particular location on the body, is the outermost visible layer of our skin. Its greatest measurement of 1.5 mm is found on soles of the feet and the palms of the hands. The 0.3 mm-3.0 mm thick dermis is the larger inner-layered counterpart. Very little in the world of tactile perception transpires on the surface layer, rather it is second-layer where nearly all of the sensory action occurs. Processing in the dermis is quite active, not passive.

The ability to interpret a sensation to our skin rests solely on the number of densely packed mechanoreceptors residing in a given area. Sensitivity to pressure varies considerably throughout the vast exterior of the body. Regions that are highly sensitive correlate directly with a massive number of receptors compressed into a small geographical area. Over 100 mechanoreceptors per cubic centimeter are found in the face and fingertips. By contrast, only 10 to 15 detectors are found beneath the same measure of skin in the back, torso, thigh or calf. More importantly, these sensory disparities are reflected in the amount of cortical real estate taken up by neurons representing each of these areas in the somatosensory cortex.

The largest receptors are the onion-shaped Pacinan corpuscles, which encode vibration and changes in pressure indicated by skin indentations. The tiny egg-shaped Meissner' s corpuscles (about 1/10 the size of Pacinan corpuscles) are located in the dermis on the ridges of hairless skin (the soles of your feet and the raised portions of your fingertips). Over 9,000 receptors are densely packed into each square inch, where they encode the slightest stimulation and the smallest fluctuation to the skin. These two types of receptors respond instantly if activated, but adapt quickly to initial change and cease to fire if the stimulus remains continuous.

### Tactile Learning Modality

For example, in order to produce the most accurate representation of an object, and presented with the options of: a) tracing the object, b) looking at the object while drawing it, or c) with your eyes closed, touching and feeling the object followed by drawing it, although having never seen it; counter-intuitively, option c would produce the best results.

As we navigate our way around planet Earth, 18 square feet of flexible human skin envelops our bodies. It accounts for 12-15% of the weight in the average adult human body constituting the largest of all bodily organs based on its weight and size. The skin is a tight-fitting elastic spacesuit, not only serving 24/7 as a reliable defensive barrier, but also doubling as a highly sensitive information-gathering data-recorder

Recent experiments have shown that touch is as important as vision to learning and the subsequent retention of information. The field of haptics is revealing how the sense of touch affects the way we interact with the world. It is also suggesting that, if educators engage more of the human senses in their classrooms, students might not only learn faster, but information will be easier to recall by comingling unrelated sensory modalities.

While we are accustomed to saying that we see with eyes, in reality, we actually see with the specialized cells in the occipital lobe located in the posterior region of the brain. As we know, blind individuals can learn to read, walk, talk, recognize objects and people without using the retinal-cortical pathways. Sighted individuals can produce visual images in the brain through the sense of touch, where we use our minds, rather than our eyes, to visualize.

The lateral occipital cortex and the right lateral fusiform gyms are known to be crucial in object recognition. However, input from more distant cortical areas including the sensory motor cortex and the association cortex provides additional information for constructing visualizations. New research is suggesting that the areas of the cerebral cortex that are activated when we merely look at illustrations or pictures of specific objects are also activated when we touch the same objects. It has been demonstrated that some areas in the lateral occipital cortex (formerly thought to process vision alone) can be activated by touch alone. There now appear to be multiple areas in the brain that underlie object recognition. They are highly interconnected in such a fashion that damage inflicted on one area can render other areas vulnerable to their natural ability to recognize objects.

More important, multiple brain regions participate in the completion of the brain-sight reproduction). The following brain areas are among those most involved: (1) the primary somatosensory cortex (touch), (2) the somatosendory association cortex (touch), (3) the general interpretation area (the assimilation of meaning), (4) the primary motor cortex (drawing), (5) the premotor cortex (preparing the appropriate body parts for drawing), (6) the frontal cortex (working memory for spatial tasks), (7) the frontal cortex (executive areas for task management), (8) the frontal cortex (working memory for object-recall tasks), (9) the visual cortex (seeing the drawing), (10) the visual association areas (visualization), and (11) the lateral occipital cortex (object recognition).

This brain-sight activity demonstrates that our traditional view of the singularity of visual perception cannot be supported by these findings.

Cats, nocturnal animals, and subterranean mammals (e.g., moles and gophers) rely heavily on the sense of touch when scampering about in the darkness. The keen sense of touch in humans allows us to recognize and identify objects that cannot be processed by the visual cortex when we are walking in near or complete darkness, such as in our own home with the lights out late at night. Damage to the posterior parietal areas of the brain can result in agnosia, the inability to recognize common objects (e.g., a cell phone) by merely feeling them, although the individual may have neither memory loss nor trouble recognizing the same object by sight or by the sound it makes. Such sensory deficits are typically restricted to the contralateral side of the body relative to the hemisphere that is damaged.

For young children who are struggling with simple arithmetic, a similar strategy using a brain-sight box can produce remarkable learning advances. Many young learners find arithmetic difficult, not due to the mathematical complexity, but because they have difficulty holding the concept of “number” in working memory. As a result, number sense is elusive to these young learners, since they cannot maintain visual images of the quantities in their mind's eye. If children cannot see those precise quantities in their mind's eye, they cannot manipulate them either.

Working with math manipulatives can sometimes be helpful for such children who are failing beginning arithmetic. However, allowing a child to work with math manipulatives inside a brain-sight box will yield faster and longer benefits in their development of number sense.

When children have engaged in exercises where they are working with object maniuplatives and math manipulatives on a desktop or tabletop, they often will base their recall on the visual experience. Making the transition to pencil-and-paper recordings of their thinking can be a broad cognitive leap.

Utilizing brain-sight activity, it is impossible for any visual information to be transmitted from the retina (in the back of the eyes) to the primary visual cortex in the back of the brain with the eyes closed. However, one can still “see” the object and form a mind's eye image through an intentional visualization. The methods described herein demonstrate that seeing via the mind's touch” actually will activate the same brain areas that would otherwise respond to normal observation. Consequently, a qualitatively better reproduction of an object is produced by brain-sight than by the “seeing and drawing” or “seeing and tracing” re-creations of precisely the same object.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front view of a brain-sight box.

FIG. 2 is a front left oblique view of a brain-sight box.

FIG. 3 is a rear view of a brain-sight box.

FIG. 4 is a rear left oblique view of a brain-sight box without a veil.

FIG. 5 is a rear right oblique view of a brain-sight box with a veil.

FIG. 6 is a flow chart of a method of learning using tactile modalities utilizing a brain-sight box.

FIG. 7 is a flow chart of a method of learning using tactile modalities.

### DETAILED DESCRIPTION

Before the invention is described in further detail, it is to be understood that the invention is not limited to the particular embodiments described, as such may, of course, vary. It is also to be understood that the terminology used herein is for the purpose of describing particular embodiments only, and not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed with the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, if dates of publication are provided, they may be different from the actual publication dates and may need to be confirmed independently.

It should be further understood that the examples and embodiments pertaining to the systems and methods disclosed herein are not meant to limit the possible implementations of the present technology. Further, although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the Claims.

In one embodiment of the present invention, the brain-sight box is a rectangular box with a lid, two holes on one face, and a means for obfuscating the view into the interior of the box through the two holes. Object manipulatives are small objects which can include small insect models, commercial place value blocks and geometric shapes. Math manipulatives are small object that can be used for displaying placeholder operations, and can comprise small plastic or wooden cubes.

The brain-sight box is teaching and learning tool built on the principle that the human sense of touch makes a significant contribution in the visualization of objects. Sighted individuals can produce visual images inside the brain (commonly referred to as the “mind's eye”) via the sense of touch, where we use our minds, rather than our eyes, to visualize concrete objects allowing us to “get a picture” of that object. Through tactile sensory input, we perceive the “qualia” (Latin for “aspects”) of an object. It is the qualia that we use to comprehend and subsequently explain the qualitative or subjective features in objects. The somatosensory cortex, where the sense of touch is processed in the brain, is directly connected to the lateral occipital cortex, the brain region responsible for processing the sense of sight. Tactile activations in the lateral occipital cortex turn out to be essential, rather than tangential, to visual recognition. Multi-modal recognition by these brain regions is what makes for human Brain-sight experiences.

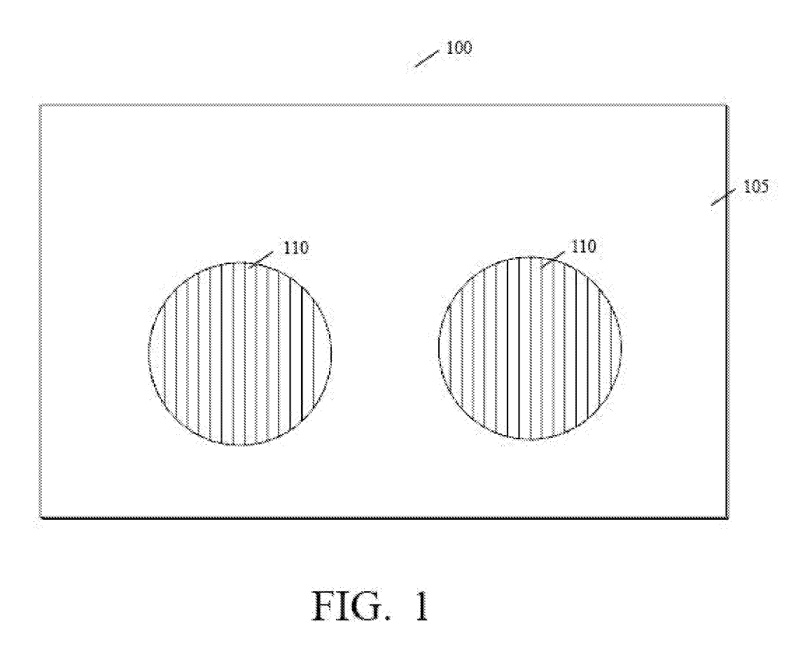

Turning to FIG. 1, shown is a front view of a brain-sight box 100 in which can be seen the front face 105 and two holes 110 which allow a student to place his/her hands into the brain-sight box without being able to see the contents therein. Each hole 110 measures approximately four inches in diameter, large enough for a student to insert both hands into the box, and covered by a veil such that their hands and the objects to be manipulated cannot be seen by their eyes.

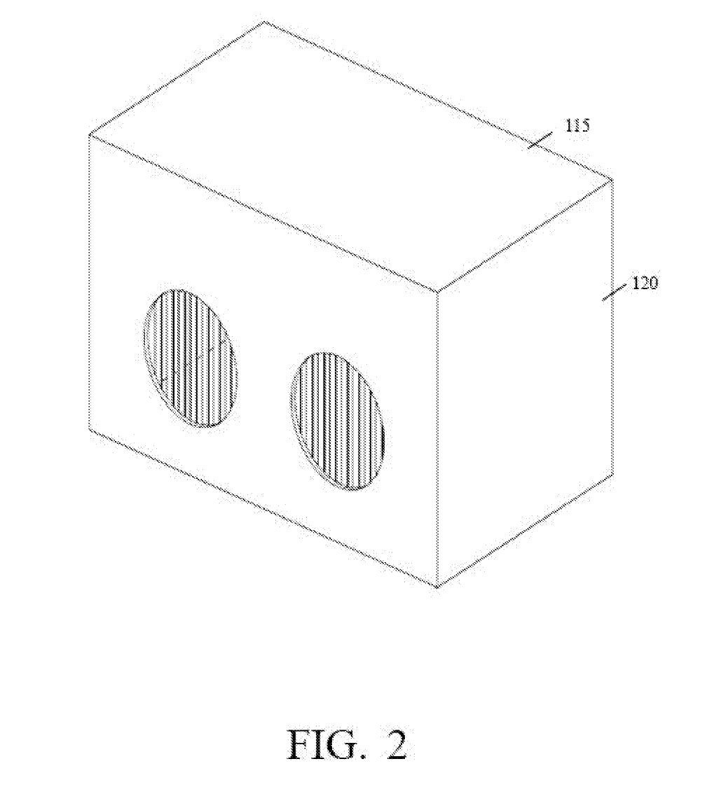

Turning to FIG. 2, shown is a front left top oblique view of a brain-sight box also showing the top face 115 and right face 120 of the brain-sight box.

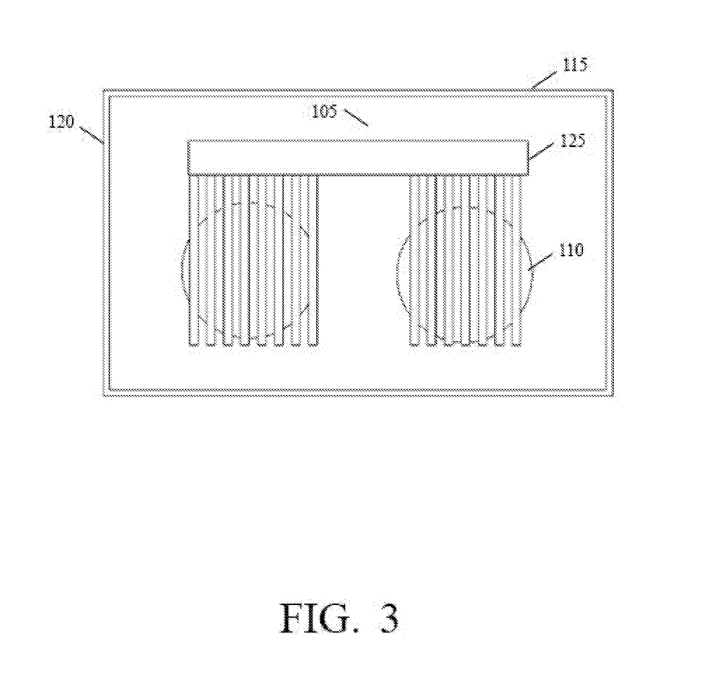

FIG. 3 shows a rear view of the brain-sight box without a rear face. The inside of the front face 105 can be seen with the veil 130 connectively attached to the inside of the front face 105 to cover the openings created by the holes 110 in order to conceal the objects that will be placed on the inside of the brain-sight box for examination/experience by a student. In one embodiment, the veil 130 is a thin strip of cloth measuring approximately 7×11 inches, wherein the top 2 inches of the strip is solid cloth with adhesive on one side that is adhered to the inside of the front face 105 of the brain-sight box approximately ¼ to ½ inch above the two holes 110 and the lower 5 inches of the veil has slits every ½ inch to form the veil 130, which prevents the student from seeing inside the box. In one embodiment of the present invention, the rear face is hingedly attached to the box so that it can be opened to reveal the contents of the box to the teacher, while keeping the contents obscured to the student. In another embodiment, this is accomplished by a box without a rear face. In another embodiment, the top face is hingedly attached to the box whereby it can be raised or opened to deposit or remove object manipulatives and/or math manipulatives.

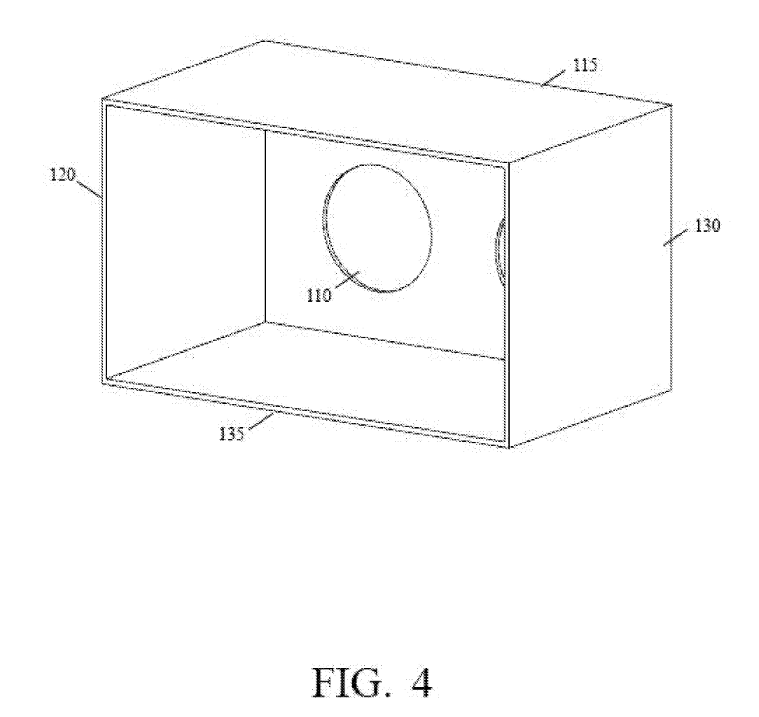

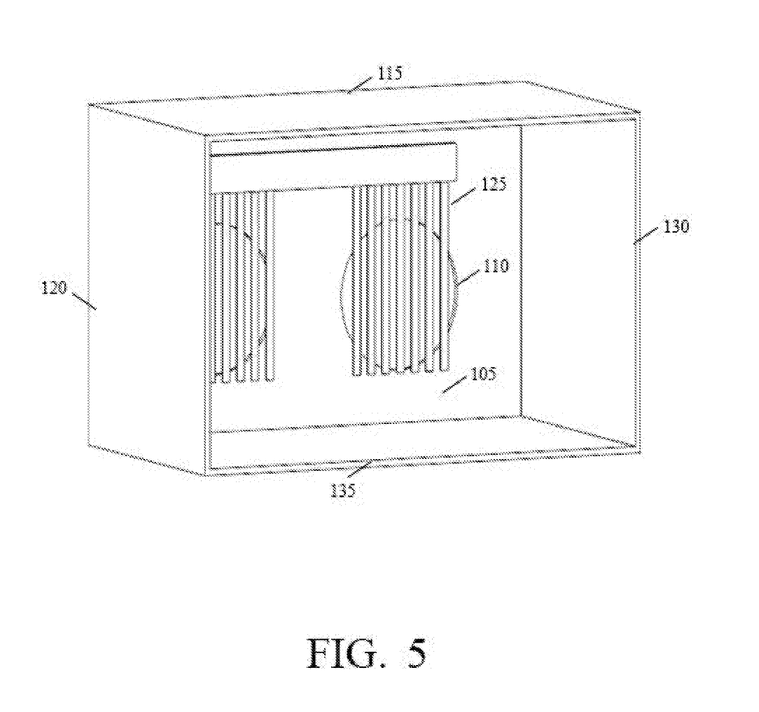

Turning now to FIG. 4, shown is a rear left top oblique view of brain-sight box 100 without a veil in which the top face 115, right face 120, left face 130 and bottom face 135 can seen. Additionally, the holes 110 in the front face 105 can be seen. FIG. 5 shows the brain-sight box 100 with the veil 125 attached to the inside of the front face 105. In other embodiments, the veil can be attached to the outside of the front face 105 or the front portion of the inside of the top face 115.

Turning now to FIG. 5, the flow chart shows a method for enhancing cognitive performance, starting with a user viewing a number of object manipulatives 510. The object manipulatives are placed inside a brain-sight box 520 which has two openings to allow the user to insert his/her hands into the box. The user then gets an arithmetic problem to solve 530. After receiving the problem, the user places his/her hands inside brain-sight box through the two openings 540 and then verbalizes the arithmetic problem and solution while manually manipulating the object manipulatives 550. In another embodiment, the student also manipulates math manipulatives. After the user verbalizes the solution to the arithmetic problem, the user removes his/her hands from the brain-sight box 560 and the arithmetic problem is again posed to the user 570 who then solves the arithmetic problem in a tradition manner using pen and paper 580.

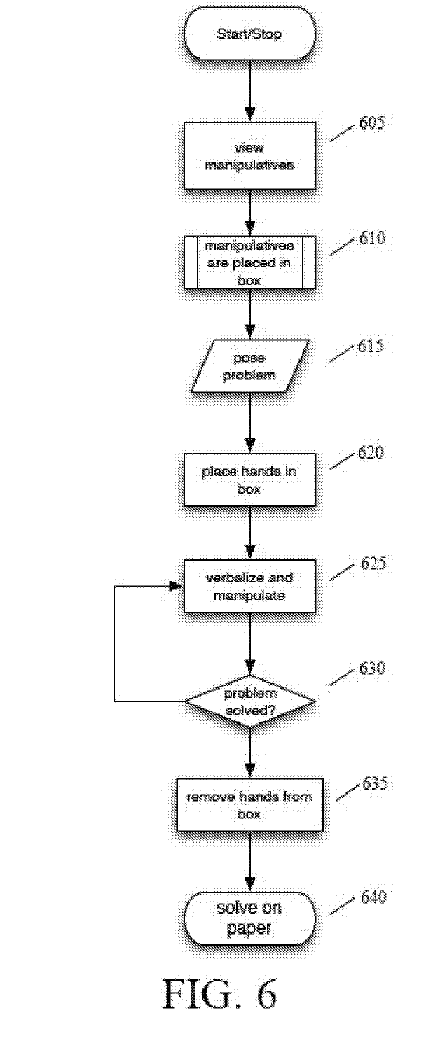

Turning now to FIG. 6, the flow chart shows a method for teaching using tactile modalities starting with a teacher showing a student the objects that the student will be manipulating inside the brain-sight box 605 and then placing the object manipulatives and math manipulatives, said math manipulatives comprising place holder blocks, on the inside of a brain-sight box 610, such that the student cannot see the object manipulatives or math manipulatives, but the teacher can. The teacher then poses a simple problem for the student 615. Examples of questions that the teacher could pose include “Can you show me five objects?”, “Can you show me two less than five?”, “Can you show me three objects plus two objects?”, “Which object is a circle?”, “Which object is a square?”, “Which object is a triangle?”, “Which object is a rectangle?”, and “Which object has four sides?”. The student then places his/her hands into the brain-sight box 620 and demonstrates and verbalizes his/her understanding of the arithmetic problem 625 while manipulating the objects in the brain-sight box without seeing them. If the student does not immediately solve the problem, or if multiple problems are to be presented 630, the student continues to verbalize and manipulate the objects 625 until the problem or problems are solved 630. When the student can perform simple arithmetical operations, such as addition and subtraction, inside the brain-sight box, the student then removes his/her hands from the brain-sight box 635, and the teacher poses the same problems for the student to solve using pen and paper 640.

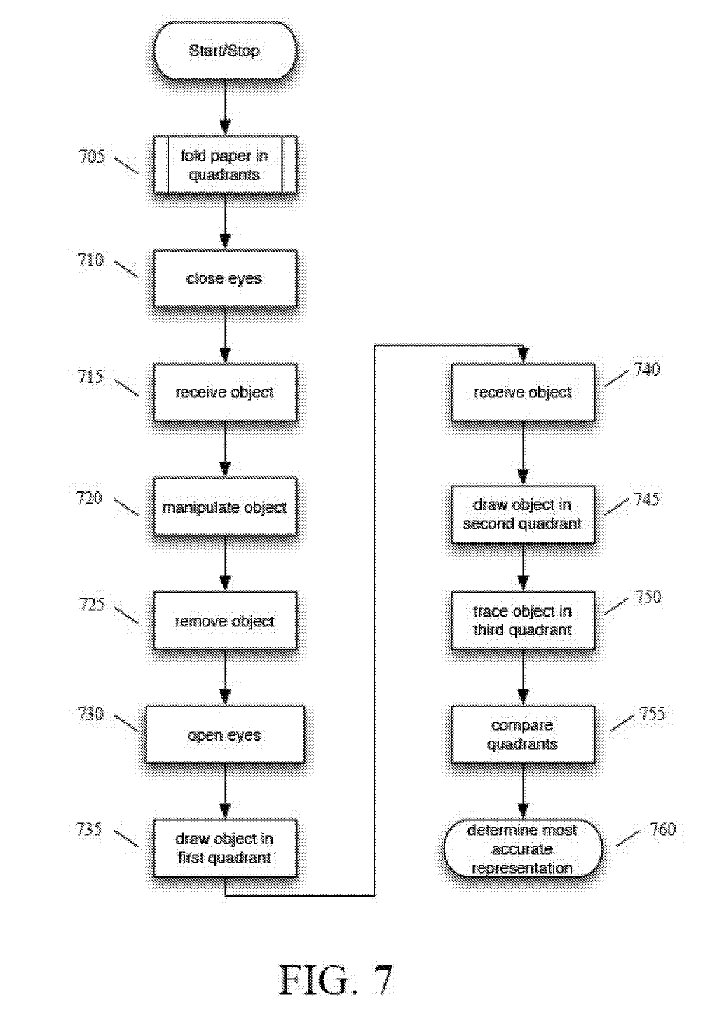

Turning now to FIG. 7, the flow chart shows a method for learning using tactile modalities starting with a student folding a sheet of graph paper into quadrants 705 and then closing his/her eyes 710 until instructed to open them. A teacher than gives the student a small object manipulative comprising an object or toy model 715. With eyes remaining closed, the student touches, feels, examines, explores, and visualizes the object with both hands 720. In one embodiment, the manipulation is performed in a brain-sight box. After manually examining the object, the object is removed by to the teacher 725, who places it where the student cannot see it. The student is then invited to open his/her 730 eyes and draw the object in the first quadrant of the graph paper 735 based exclusively on the tactile information derived from the sensory experience (not memory or “guessing” the object). The student may re-examine the object additional times, if necessary, but only with his/her eyes closed again. The teacher then returns the object to the student 740 and the student then views the object while drawing it in the second quadrant of the graph paper 745. The student then traces the object in the third quadrant of the graph paper 750. Student then compares the drawings in the first, second and third quadrants 755 and determines the most accurate representation of the object 760.

In the preceding brain-sight activity, it was impossible for any visual information to be transmitted from the retina (in the back of your eyes) to the primary visual cortex in the back of your brain with your eyes closed. However, you still could “see” the object and form a mind's eye image through intentional visualization. These procedures demonstrate that “seeing via the mind's touch” actually will activate the same brain areas that would otherwise respond to normal observation. Consequently, a qualitatively better reproduction of the object was produced by brain-sight than by the “seeing and drawing” or “seeing and tracing” re-creations of precisely the same object.

Counter-intuitively, the first of the three drawings (the brain-sight or “sightless” version) will almost invariably be drawn completely to scale and in perfect proportion. This brain-sight experience demonstrates that the traditional view of the singularity of visual perception can no longer be supported based on these new brain-sight findings.

For young students who are struggling with simple concepts in arithmetic, a brain-sight box can produce remarkable learning advances. Many young students find number concepts difficult to process, not because of the mathematical complexity inherent in the problems, but because the students have difficulty holding the concept of number in their mind's eye for mental manipulation. As a result, number sense is elusive to these young students, since they cannot maintain visual images of the objects and their quantities in their mind's eye where they must be mentally manipulated to solve a number problem. If students cannot “see” those precise quantities in their mind's eye, they cannot manipulate them mathematically.

When students engage in exercises where they are working with math manipulatives on a desktop or tabletop, they often will base their recall on the visual experience. Making the transition to pencil-and-paper recordings of their thinking can be a broad cognitive leap. Working with math manipulatives inside a brain-sight box is extremely helpful for elementary age children. However, allowing a child to work with math manipulatives inside a brain-sight box will yield faster and longer learning benefits in their development of number sense.

The somatosensory cortex, where the sense of touch is processed, turns out to be directly connected to the lateral occipital cortex, the brain region responsible for sight. Tactile activations in the lateral occipital cortex turn out to be essential, rather than tangential, to visual recognition. The lateral occipital cortex can be triggered by touch. Multi-modal recognition by these brain regions is what makes “brain-sight” experiences successful.

It should be further understood that the examples and embodiments pertaining to the systems and methods disclosed herein are not meant to limit the possible implementations of the present technology. Further, although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the Claims.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

What is claimed is:

1. An apparatus for teaching a student utilizing a tactile modality wherein a lateral occipital cortex of the student is activated via a somatosensory cortex, the apparatus comprising:
a plurality of object manipulatives;
a box comprising a front face, a right face, a left face, a top face hingedly attached to said box whereby said top face can be raised to allow insertion of said plurality of object manipulatives into said box, a rear face hingedly connected to said box whereby said rear face can be opened to allow the interior of said box to be viewed from the rear by a teacher from behind, and a bottom face, wherein said box is configured with two openings approximately four inches in diameter placed on said front face and a veil affixed to said box and covering said two openings, whereby the interior of said box cannot be viewed by said student through said openings and whereby the student may access the interior of said box by placing his/her hands through said two openings;
wherein manipulation of said plurality of object manipulatives by said student in response to a posed arithmetic problem followed by the issuance of a written solution to said arithmetic problem by said student causes said lateral occipital cortex to be activated via said somatosensory cortex of said student.

2. The apparatus of claim 1 wherein said veil comprises a thin strip of cloth measuring approximately 7×11 inches, wherein a top 2 inches of said strip of cloth is solid with adhesive on one side that is adhered inside of said front face above said two openings and a lower 5 inches of the veil has slits at half inch intervals.

3. An apparatus for teaching mathematics to a student utilizing a tactile modality, said apparatus comprising:
a box configured with two openings;
a plurality of object manipulatives;
means for selecting said plurality of object manipulatives;
means for presenting said student with said plurality of object manipulatives;
means for placing said plurality of object manipulatives inside said box configured with two openings;
means for presenting said student with an arithmetic problem and directing said student to place each of said student's hands into said box configured with two openings by placing each hand into each of said openings of said box configured with two openings;
means for instructing said student to verbalize a concept of said arithmetic problem while manually manipulating said plurality of object manipulatives;
means for removing said student's hands from said box;
means for posing said arithmetic problem to said student; and
means for instructing student to write a solution to said arithmetic problem.
